(19) United States
(12) Patent Application Publication
(10) Pub. No.: US 2007/0260756 A1
(43) Pub. Date: Nov. 8, 2007

(54) Method for Processing Command via SATA Interface

(76) Inventors: Pao-Ching Tseng, Jhubei City (TW); Ching-Yi Wu, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/279,261

(22) Filed: Apr. 11, 2006

Related U.S. Application Data
(63) Continuation-in-part of application No. 11/306,661, filed on Jan. 5, 2006.

(51) Int. Cl. G06F 3/00

(52) U.S. Cl. 710/5

(57) ABSTRACT

Methods for performing ATAPI NCQ and ATAPI normal command are provided. The method involves receiving a predefined packet comprising essential information regarding a host command, the predefined packet received from a Serial ATA interface that is coupled to a host, wherein the essential information further indicates whether the command is a NCQ command; executing the command; and sending a completion packet to the host over the Serial ATA interface for indicating that the command was executed.

### BACKGROUND OF THE INVENTION

The invention relates to a method and a device for implementing Advanced Technology Attachment Packet Interface (ATAPI) Native Command Queuing (NCQ) over a Serial Advanced Technology Attachment (SATA) interface.

The Advanced Technology Attachment (ATA) is an interface specification and is applied to the transmission interface between host systems and storage devices. It is an interface comes with 40 or 80 signal lines in parallel. The ATA specification specifies some feature sets like as Queued feature set. The Queued feature set allows the host to issue concurrent commands to the same device. Some ATA commands are allowed to be queued. These commands include PACKET command (A0h), READ DMA QUEUED command (C7h), READ DMA QUEUED EXT command (26h), WRITE DMA QUEUED command (CCh), WRITE DMA QUEUED EXT command (36h).

Please refer to FIG. 1. FIG. 1 is a timing diagram illustrating Advanced Technology Attachment (ATA) command queuing. In command queuing, an ATA host 120 issues a series of commands to an ATA device 125. The device 125 then determines the most efficient order of executing the commands, and executes the commands in the queue accordingly. In FIG. 1, the host 120 issues a queue command having a command tag=0 in step 130. The device 125 performs a bus release and clearing the busy flag in step 132 to indicate that the device 125 is able to receive additional commands from the host 120. In this example, the host 120 issues two commands to the device 125 for illustrating the ability of the device 125 to perform out-of-order execution. After the busy flag is cleared, the host 120 issues another queue command having a command tag=1 in step 134. The device 125 performs a bus release and clears the busy flag in step 136. In step 138, the device 125 is ready to transfer data and complete the command via SERVICE request. The device 125 sets a service bit (SERV) to 1 to signal the data transfer phase. The host 120 issues a service command in step 140 and looks into the I/O registers and finds out the tag number. In this case, we assume that tag number read from the device is 1 to demonstrate the out of order execution. Next, in step 142, software in the host 120 programs a Direct Memory Access (DMA) engine of the host and point the hardware to a correct data buffer for storing incoming data or transferring data to the device 125. Next, in step 144, Device executes the queued command with tag=1 and begins data transfer, and data is either transmitted from the host 120 to the device 125 or is received by the host 120 from the device 125.

In FIG. 1, steps 130-136 can be thought of as a command phase for entering the commands in the queue of the device 125. Steps 138-144 can be labeled as a data phase for executing data transfer commands. Unfortunately, the data phase has a great deal of overhead that complicates the data transfer process and slows down the transfer of data.

The Serial Advanced Technology Attachment (SATA) standard was introduced in the early 21 st century. It is an interface specification initially promoted by the companies of APT, Dell, IBM, Intel, Maxtor, Seagate, etc. The SATA specification is applied to the transmission interface of a hard disk drive or an optical disk drive to replace parallel ATA/ATAPI interface that has been used for a long time. The SATA interface specification specifies two pairs of differential signal lines to replace the original 40 or 80 signal lines connected in parallel. Serializing the original data can reduce the size and voltage, and increase the speed. While serializing the signal line, the SATA specification still keeps most of the concept of ATA specification, such as the definition of I/O registers, command sets, etc. It uses packet to transfer those I/O registers, and payload between the host and the device. Packets are referred as Frame Information Structure (FIS) in the SATA spec. Besides, the SATA specification also introduces some new functions, such as First Party DMA to facilitate the data transfer between the host and the device. In order to distinguish the difference between these two interfaces, parallel Advanced Technology Attachment (PATA) will be used to refer to the traditional parallel 40 or 80 line interface, Serial Advanced Technology Attachment (SATA) will be used to refer to the serialized interface. However, both of the PATA and SATA can carry ATA or ATAPI command sets.

Please refer to FIG. 2. FIG. 2 is a timing diagram illustrating Serial Advanced Technology Attachment (SATA) Native Command Queuing (NCQ). The SATA NCQ protocol is currently applied to hard disk drives for allowing data read and write commands in a queue to be executed out of order. The SATA NCQ protocol is an improvement over the command queuing protocol explained above, and utilizes first party DMA for transferring data. A SATA host 150 sends a Register Frame Information Structure (FIS) 160 having a command with tag=0 to a SATA device 155. The device 155 responds with a Register FIS 162 acknowledging the Register FIS 160 and clearing the busy flag to indicate that the device 155 is able to receive additional commands from the host 150. The host 150 then sends another Register FIS 164 having a command with tag=1, and the device 155 responds with register FIS 166. In this example, it is assumed that both of the commands issued from the host 150 to the device 155 are commands for reading data from the device 155. The steps described above are known as the command phase and the steps described below are known as the data phase of SATA NCQ protocol.

Since the device 155 has received two commands from the host 150, the device 155 must decide which of the two commands to execute first. In this case, the command with tag=1 will be executed before the command with tag=0 for illustrating out-of-order execution. In step 168, the device transmits a DMA Setup FIS for setting up the DMA transfer for the command with tag=1. After the DMA is setup, the data transfer for the command with tag=1 is performed in step 170. These two steps are repeated for the command with tag=0 in steps 172 and 174.

The SATA NCQ protocol is an improvement over the command queuing protocol because the data phase has much less overhead, and the software of the host 150 does not need to manually control data transfer as in the command queuing protocol. With NCQ, first party DMA is used, and the hardware will check the tag number of the command and load the data to the specific buffer corresponding to the tag number. On the other hand, with command queuing, software needs to issue a SERVICE command and specify a buffer to be used for data transfer when the device send an indication to host for transferring data, which increases the complexity and the overhead involved for data transfer.

However, ATAPI device is using different scheme to pass the commands to the device. ATA devices use the I/O registers to pass the commands. The command code is carried by the command register; the parameters are carried by the rest of the registers. For ATAPI device, host put 0xA0 in the command register to indicate ATAPI packet command phase, and then use the data register to pass 12 bytes data (referred as command data block or CDB) for the ATAPI commands. So the current NCQ is only available for hard disk drives (referred to as ATA NCQ in the following), and is not available for devices utilizing the Advanced Technology Attachment Packet Interface (ATAPI) such as optical disk drives like CD-ROM drives and DVD-ROM drives, as well as other devices. Since NCQ is currently unavailable for ATAPI devices, only ATA devices are able to benefit from the advantages that NCQ brings.

Besides, in the normal command phase, issuing an ATAPI command should involve three Frame Information Structures (FISs). First the host needs to issue a Register FIS, then the device will response a PIO Setup FIS, and then the host can issue a Data FIS containing the ATAPI CDB. It consumes more FISs than ATA command phase. It leaves room for further enhancement.

### SUMMARY

Methods for performing ATAPI NCQ are provided. An exemplary embodiment of the method includes receiving a predefined packet comprising an ATAPI command and a plurality of parameters, the predefined packet received from a Serial ATA interface that is coupled to a host; sending an acknowledgement to said host over said Serial ATA interface, said acknowledgement indicating that a bit within said host should be cleared in order to indicate that said Serial ATA interface is no longer busy; sending a data transfer setup packet comprising one of the parameters to the host over the Serial ATA interface; executing the data transfer corresponding to the command received from the host in the predefined packet; and sending a completion packet to the host over the Serial ATA interface for indicating that the command was executed.

Another exemplary embodiment of the methods for performing ATAPI command in a normal command phase is also provided. The method includes receiving a predefined packet comprising essential information regarding a host command, the predefined packet received from a Serial ATA interface that is coupled to a host, wherein the essential information further indicates whether the command is a NCQ command; executing the command; and sending a completion packet to the host over the Serial ATA interface for indicating that the command was executed.

### BRIEF DESCRIPTION OF THE DRAWINGS

FIG. 1 is a timing diagram illustrating ATA command queuing.

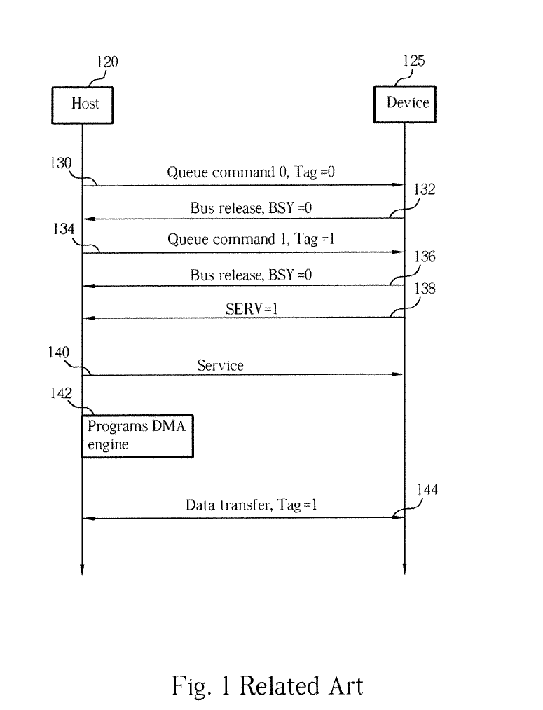

FIG. 2 is a timing diagram illustrating ATA NCQ.

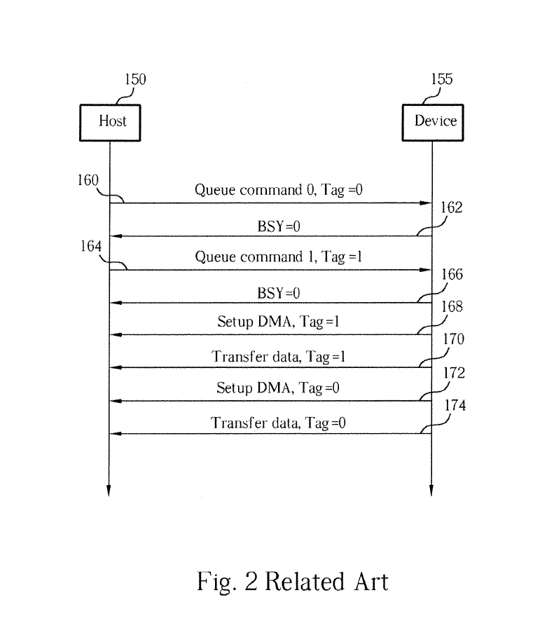

FIG. 3 is a timing diagram illustrating ATAPI NCQ according to a first illustrative embodiment.

FIG. 4 is a timing diagram illustrating ATAPI NCQ according to a second illustrative embodiment.

FIG. 5 is a timing diagram illustrating ATAPI NCQ according to a third illustrative embodiment.

FIG. 6 is a timing diagram illustrating ATAPI NCQ according to a fourth illustrative embodiment.

FIG. 7 is a timing diagram illustrating ATAPI NCQ according to a fifth illustrative embodiment.

FIG. 8 is a timing diagram illustrating ATAPI command transmitted over a SATA interface according to the fifth embodiment.

FIG. 9 is a timing diagram illustrating ATAPI NCQ according to a sixth illustrative embodiment.

### DETAILED DESCRIPTION

The following explains a way of implementing Advanced Technology Attachment Packet Interface (ATAPI) Native Command Queuing (NCQ) over a Serial ATA interface. The method makes use of first party DMA for transferring data, but uses commands that are specifically required for the ATAPI standard.

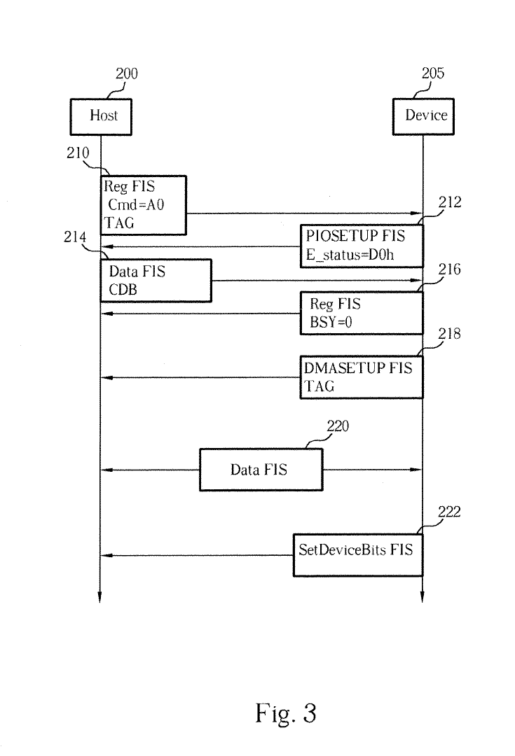

Please refer to FIG. 3. FIG. 3 is a timing diagram illustrating ATAPI NCQ according to a first illustrative embodiment. A SATA host 200 is shown transferring data with a SATA device 205. First of all, the host 200 issues a Register Frame Information Structure (FIS) 210 containing a command register set to 0xA0 and a tag indicating a reference number for the command. The hexadecimal code 0xA0 indicates that 12 bytes data will be transferred from host to device to pass an ATAPI command. The tag is used as a reference number for this particular command so as to distinguish from other commands that the host 200 may issue the device 205. After the device 205 receives the Register FIS 210, the device 205 responds with a PIO Setup FIS 212 having an E_Status of the PIO Setup FIS being set to be 0xD0. Next, the host 200 sends a Data FIS 214 containing a command data block (CDB) to the device 205. The CDB consists of 12 bytes data, and is used to pass the ATAPI command. The device 205 completes the command phase by transmitting another Register FIS 216 to the host 200 for clearing the busy flag (i.e. setting BSY=0). After the busy flag has been cleared, the device 205 can receive additional commands from the host 200. For simplicity, however, the timing diagram in FIG. 3 only illustrates the execution of a single command since one skilled in the art can easily extend this example to two or more commands being operated on in order or out of order.

The device 205 prepares for the data transmission by issuing a DMA Setup FIS 218 containing the tag to the host 200. The tag indicates which command the data that is about to be transmitted corresponds to. Next, the command received from the host 200 in the Data FIS. 214 is executed in one or more Data FIS. 220. Depending on if the host 200 is reading data from the device 205 or is writing data to the device 205, the direction of the Data FIS packets 220 will vary accordingly. After the data has been transferred, the device 205 transmits a Set Device Bits FIS. 222 to the host 200 for indicating that the command was successfully executed and for releasing the tag number.

In the timing diagram of FIG. 3, four FIS are required in the command phase to perform the communication required for receiving a command from the host 200, communicating with the host 200, and clearing the busy flag. Alternatively, another scenario exists in which only three FIS are required in the command phase.

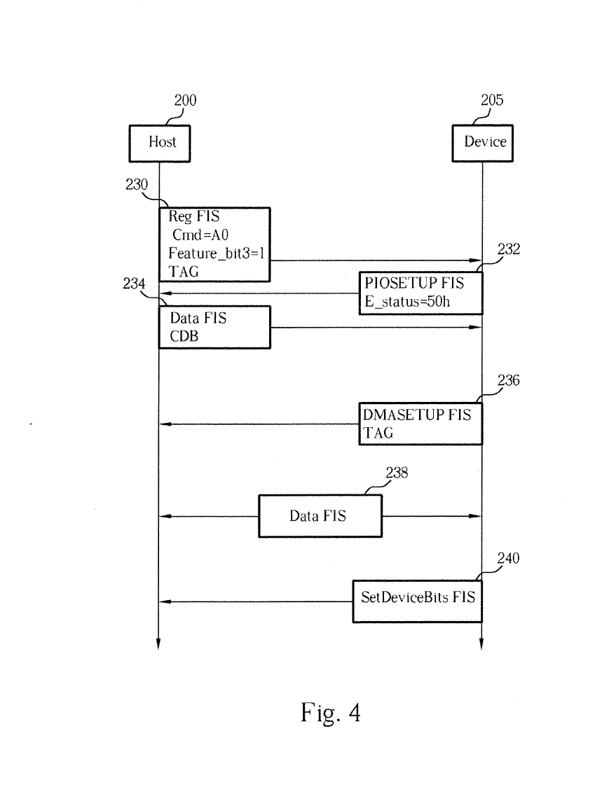

Please refer to FIG. 4. FIG. 4 is a timing diagram illustrating ATAPI NCQ transmitted over a SATA interface according to a second illustrative embodiment. The host 200 issues a Register FIS. 230 containing a command register set to 0xA0 and a tag indicating a reference number for the command. The Register FIS. 230 contains the hexadecimal code 0xA0 for indicating that 12 bytes data will be transferred from host to device to pass an ATAPI command and also sets Feature_bit3=1 to indicate that this is an NCQ command. After the device 205 receives the Register FIS. 230, the device 205 responds with a PIO Setup FIS. 232. Unlike the PIO Setup FIS. 212 shown in FIG. 3, the PIO Setup FIS. 232 has an E_Status set to be 0x50 instead of 0xD0. The effect of this is setting the most significant bit of the status to be equal to 0 instead of 1 allows the PIO Setup FIS. 232 to clear the busy flag instead of requiring an extra Register FIS for this purpose. Next, the host 200 sends a Data FIS. 234 containing a command data block (CDB) to the device 205. After the busy flag has been cleared with the PIO Setup FIS. 232, the device 205 can receive additional commands from the host 200. Thus, the second illustrative embodiment requires only three FIS packets in the command phase since one Register FIS packets is saved by clearing the busy flag with the PIO Setup FIS. 232.

As with the first illustrative embodiment shown in FIG. 3, the device 205 prepares for the data transmission by issuing a DMA Setup FIS 236 containing the tag to the host 200. The tag indicates which command the data that is about to be transmitted corresponds to. Next, the command received from the host 200 in the Data FIS. 234 is executed in one or more Data FIS packets 238. After the data has been transferred, the device 205 transmits a Set Device Bits FIS. 240 to the host 200 for indicating that the command was successfully executed and for releasing the tag number.

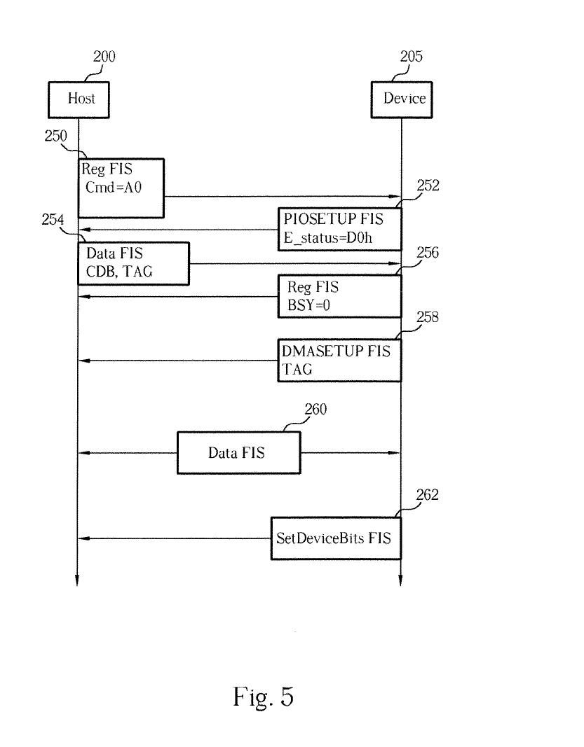

Please refer to FIG. 5. FIG. 5 is a timing diagram illustrating ATAPI NCQ according to a third illustrative embodiment. A SATA host 200 is shown transferring data with a SATA device 205. First of all, the host 200 issues a Register Frame Information Structure (FIS) 250 containing a command register set to 0xA0. After the device 205 receives the Register FIS. 250, the device 205 responds with a PIO Setup FIS. 252 having an E_Status of the PIO Setup FIS being set to be 0xD0. Next, the host 200 sends a Data FIS. 254 containing a command data block (CDB) to the device 205. And the CDB contains a tag number for indexing the queued commands. The device 205 completes the command phase by transmitting another Register FIS. 256 to the host 200 for clearing the busy flag (i.e. setting BSY=0). The device 205 prepares for the data transmission by issuing a DMA Setup FIS. 258 containing the tag to the host 200. Next, the command received from the host 200 in the Data FIS. 254 is executed in one or more Data FIS. 260. After the data has been transferred, the device 205 transmits a Set Device Bits FIS. 262 to the host 200 for indicating that the command was successfully executed and for releasing the tag number.

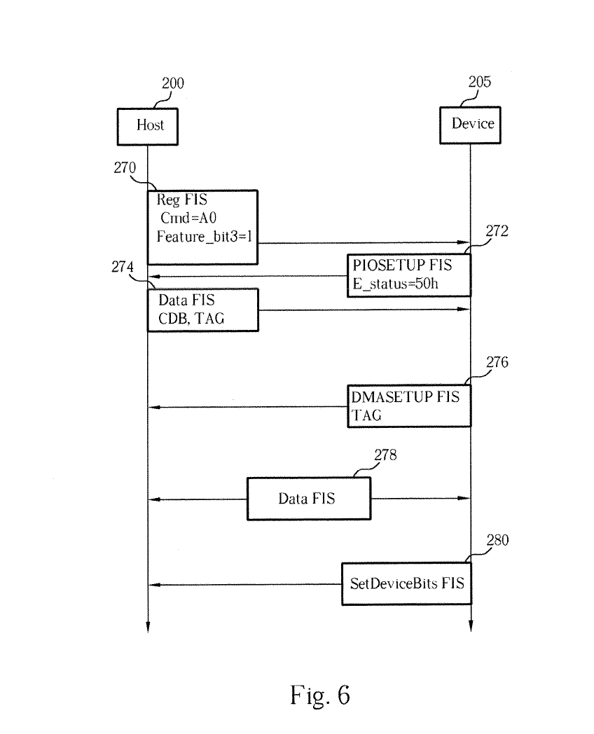

Please refer to FIG. 6. FIG. 6 is a timing diagram illustrating ATAPI NCQ transmitted over a SATA interface according to a forth illustrative embodiment. The host 200 issues a Register FIS. 270. The Register FIS. 270 contains the hexadecimal code 0xA0 and sets Feature_bit3=1 to indicate that this is an NCQ command. After the device 205 receives the Register FIS. 270, the device 205 responds with a PIO Setup FIS. 272 with an E_Status set to 0x50. Next, the host 200 sends a Data FIS. 274 containing a command data block (CDB) to the device 205. The CDB further contains a tag number for indexing queued commands. Then the device 205 prepares for the data transmission by issuing a DMA Setup FIS. 276 containing the tag to the host 200. Next, the command received from the host 200 in the Data FIS. 274 is executed in one or more Data FIS packets 278. After the data has been transferred, the device 205 transmits a Set Device Bits FIS. 280 to the host 200 for indicating that the command was successfully executed and for releasing the tag number.

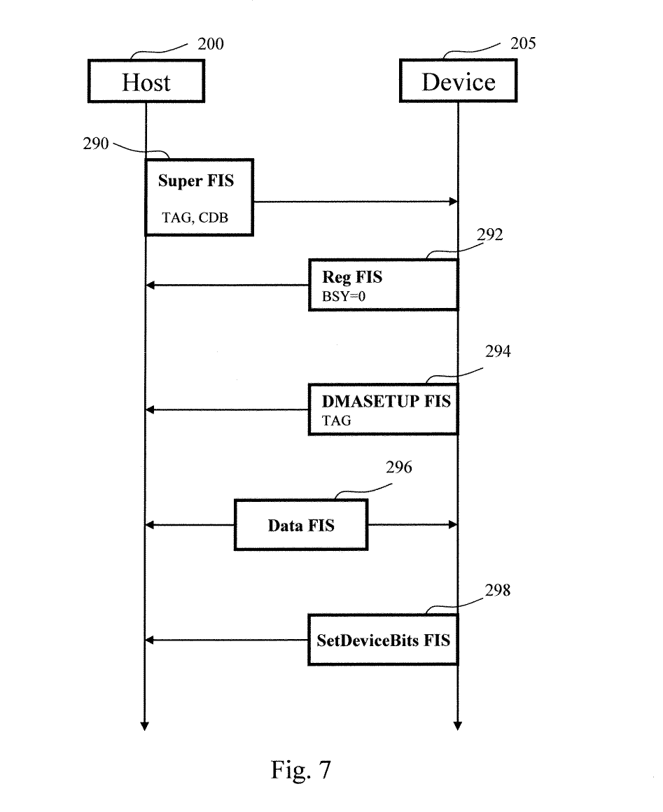

Please refer to FIG. 7 and Table 1. FIG. 7 is a timing diagram illustrating ATAPI NCQ transmitted over a SATA interface according to a fifth illustrative embodiment. Table 1 is a schematic illustration of a super FIS shown in FIG. 7. In this embodiment, a super FIS is introduced to accommodate both the necessary parameters and the ATAPI command in a single FIS. The host 200 issues a super FIS. 290. The super FIS. 290 is a predefined packet and contains 20 bytes. The super FIS comprises the necessary parameters and a command data block (CDB) to the device 205. The necessary parameters contain a tag number for indexing queued commands, a command register, an N for indicating NCQ state, and a PRIO for identifying the priority of the ATAPI command. When N set to 1, it indicates the ATAPI command shall be treated as NCQ command, and can be executed out of order. When N set to 0, it indicates the ATAPI command shall be treated as regular ATAPI command, and shall be executed in order. That is to say the super FIS can also be used for normal (non-NCQ) commands.

Please note that, although full 12 bytes are showed in the Table 1 for the ATAPI CDB, it is possible to pass only part of the ATAPI command instead a full CDB. For example, said part of the ATAPI command could be the LBA information, transfer length, and read/write indication. In the following, a command instruction will be used to refer to said part of the ATAPI command, the event or the essential information associate with an ATAPI command. Namely both a read 10 command, and a read indication with desired location to an ATAPI device to retrieve a 2048 bytes data format sector will be considered as ATAPI instructions. For those skilled in the art will know, the ATAPI command used in this disclosure should include such ATAPI instructions.

When the parameter N indicates the command in the super FIS is a NCQ command, the device 205 completes the command phase by transmitting a Register FIS. 292 to the host 200 for clearing the busy flag (i.e. setting BSY=0). The Device 205 will try to optimize the execution order of those queued commands. Up to a certain time when the device 205 is about to transmit the data for the command with the tag in super FIS. 290, the device 205 prepares for the data transmission by issuing a DMA Setup FIS. 294 containing the tag to the host 200. Next, the command received from the host 200 in the super FIS. 290 is executed in one or more Data FIS packets 296. Note that if the command is executed to transmit data regarding optical media, such as read/write data from/to an optical media, the sector size is usually 2048 bytes per sector. The transfer length would be number of sectors times 2048. After the data has been transferred, the device 205 transmits a Set Device Bits FIS. 298 to the host 200 for indicating that the command was successfully executed and for releasing the tag number.

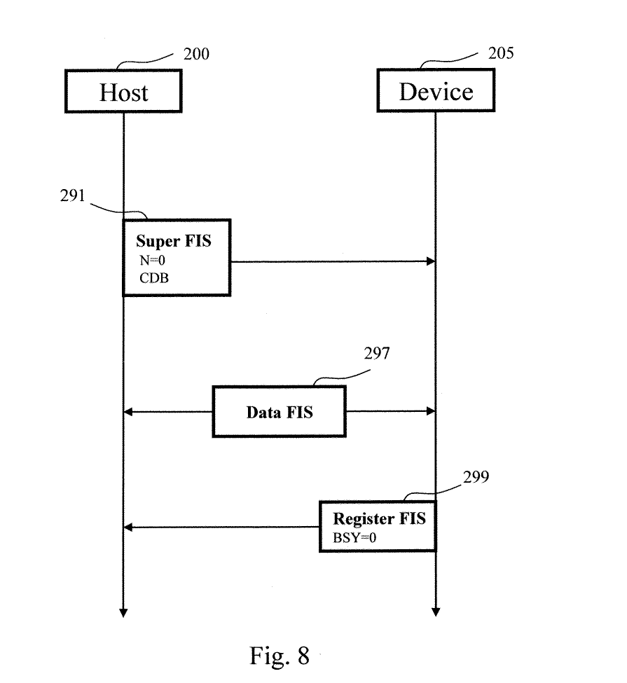

Please refer to FIG. 8, which is a timing diagram illustrating ATAPI command transmitted over a SATA interface according to the fifth embodiment when it is used to carry normal commands (non-NCQ commands). A host 200 can send an ATAPI command to a device 205 by only a super FIS. 291 illustrated in this embodiment. As described in the background art, issuing an ATAPI command should involve three FISs. First the host needs to issue a Register FIS, then the device will response a PIO Setup FIS, and then the host can issue a Data FIS containing the ATAPI CDB. By using the super FIS. 291, it will save the usage of two FISs in a command phase. Besides, according to the current SATA spec, Data FIS will not be retransmitted when noise pollutes the channel and the CRC check fails. This will cause some trouble for some noisy channel with traditional way of passing ATAPI CDB by Data FIS. So by maintain the re-transmission policy for Super FIS, this will help to improve the command delivery with noisy channel.

After the host sends a command by the Super FIS. 291, the device 205 executes the command by one or more Data FIS. 297. After the data has been transferred, the device 205 transmits a Register FIS. 299 to the host 200 for indicating that the command was successfully executed and clear the busy flag.

TABLE 1
Schematic illustration of a super FIS

| | | | | | |
|---|---|---|---|---|---|
| 0 | PRIO | Reserved | Reserved | PM Port | FIS Type (A0h) |

| | | | | | | | | | | | |
|---|---|---|---|---|---|---|---|---|---|---|---|
| 1 | TAG | N | R | R | R | R | R | R | R | Reserved | Reserved |

| | | | | |
|---|---|---|---|---|
| 2 | CDB_3 | CDB_2 | CDB_1 | CDB_0 |
| 3 | CDB_7 | CDB_6 | CDB_5 | CDB_4 |
| 4 | CDB_11 | CDB_10 | CDB_9 | CDB_8 |

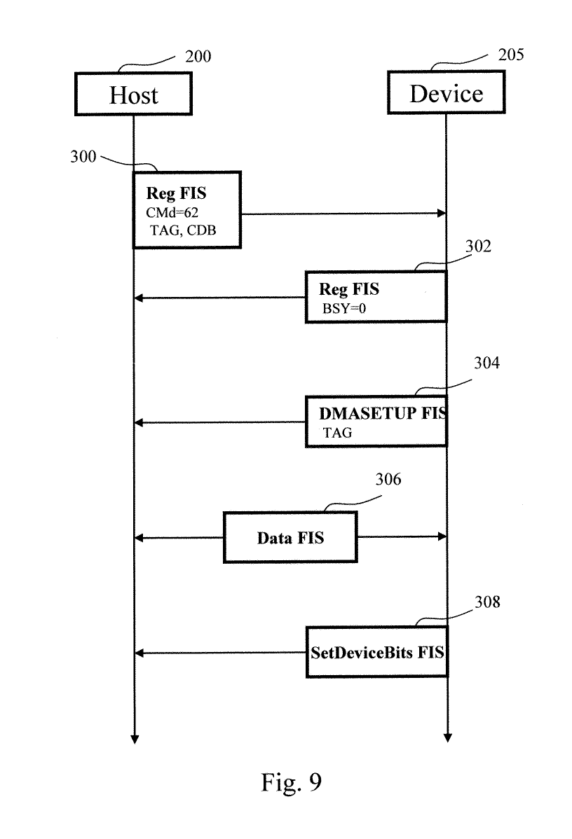

Please refer to FIG. 9 and Table 2, which is a schematic illustration showing the remapping of a host to device Register FIS according to a sixth embodiment. By remapping some of the fields, the Register FIS could be used to pass a command to read or write 2048 bytes data format media, for example CD or DVD. The indication parameter of the remapping is done by a special command code, which is not used in normal operation, for example 62h. Note that, the indication parameter of the remapping could instead by a bit in the task file, for example bit0 in the LBA Low register. The remapping technique could be used to pass an ATAPI command to an ATAPI device in both NCQ and normal case. In the case of NCQ, a device will queue commands and use first party DMA to transfer data. While in the normal case (non-NCQ), a device will execute command in order. Both in the NCQ and normal case, passing of an ATAPI command will only need one remapped Register FIS. By doing this, it could save two FIS (PIO Setup FIS and Data FIS) in the command phase. The indication parameter for NCQ could be done by a bit in a task file, or it could be done by a special command code also. The indication parameter for remapping and NCQ could be the same. For example a special command 62h could be used to indicate for both remapping and NCQ, and a special command 63h could be used to indicate for remapping and non-NCQ. In the case of the NCQ, the tag parameter for indexing queue commands is carried by the highest 5 bits of the LBA Low register. Note that instead of the LBA Low register, the tag could be carried by other field, such as Device register or CDB_1. Although full 12 bytes are showed in the Table 2, note that it is possible to pass only part of the 12 bytes ATAPI CDB, for example the LBA information, transfer length, and read/write indication.

The host 200 issues a remapped Register FIS. 300 with the remapping showed as Table 2. The host 200 signals the remapping by a special command code 62h. The device 205 completes the command phase by transmitting a Register FIS. 302 to the host 200 for clearing the busy flag (i.e. setting BSY=0). Then the device 205 prepares for the data transmission by issuing a DMA Setup FIS. 304 containing the tag to the host 200. Next, the command received from the host 200 in the Register FIS. 300 is executed in one or more Data FIS packets 306. After the data has been transferred, the device 205 transmits a Set Device Bits FIS. 308 to the host 200 for indicating that the command was successfully executed and for releasing the tag number.

TABLE 2
Register- Host to Device FIS layout

| | | | | | | | | |
|---|---|---|---|---|---|---|---|---|
| 0 | Features | command | C | R | R | R | PM Port | FIS Type (27 h) |

| | | | | |
|---|---|---|---|---|
| 1 | Device | CDB_1 | CDB_0 | LBA Low |
| 2 | CDB_5 | CDB_4 | CDB_3 | CDB_2 |
| 3 | Control | CDB_7 | CDB_6 | Sector Count |
| 4 | CDB_11 | CDB_10 | CDB_9 | CDB_8 |

In summary, the methods and the device illustrated in the six illustrative embodiments allow ATAPI NCQ utilizing first party DMA transfer to be used in SATA devices such as optical disk drives.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method comprising:
receiving a predefined packet comprising an ATAPI command and a plurality of parameters, the predefined packet received from a Serial ATA interface that is coupled to a host;
sending an acknowledgement to said host over said Serial ATA interface, said acknowledgement indicating that a bit within said host should be cleared in order to indicate that said Serial ATA interface is no longer busy;
sending a data transfer setup packet comprising one of the parameters to the host over the Serial ATA interface;
executing the data transfer corresponding to the command received from the host in the predefined packet; and
sending a completion packet to the host over the Serial ATA interface for indicating that the command was executed.

2. The method of claim 1, wherein the ATAPI command is a command instruction which comprising essential information for executing the ATAPI command.

3. The method of claim 1, wherein the predefined packet is a new defined FIS.

4. The method of claim 1, wherein the predefined packet is a new defined Register FIS.

5. The method of claim 1, wherein the parameters comprises an indication for indicating whether the ATAPI command is a NCQ command.

6. The method of claim 1, wherein the parameters comprises a command register.

7. The method of claim 1, wherein the parameters comprises a PRIO for identifying the priority of the ATAPI command.

8. The method of claim 1, wherein the parameters comprises a tag number for indexing queued read commands or queued write commands, and the data transfer setup packet also comprising the tag number.

9. The method of claim 1 wherein said acknowledgement is a Register FIS for clearing a busy flag of the host.

10. The method of claim 1, wherein the data transfer setup packet is a DMA Setup FIS.

11. The method of claim 1, wherein the completion packet is a Set Device Bits FIS.

12. The method of claim 1, wherein the ATAPI command is a read command using first party DMA for transferring data.

13. The method of claim 1, wherein the ATAPI command is a write command using first party DMA for transferring data.

14. A method for executing a host command in an ATAPI device, comprising:
receiving a predefined packet comprising a command and a plurality of parameters, the predefined packet received from a Serial ATA interface that is coupled to a host, wherein one of the parameters indicates whether the command is a NCQ command;
executing the command received from the host in the predefined packet; and
sending a completion packet to the host over the Serial ATA interface for indicating that the command was executed.

15. The method of claim 14, wherein the predefined packet is a new defined FIS.

16. The method of claim 14, wherein the predefined packet is a new defined Register FIS.

17. The method of claim 14, wherein the parameters comprise an indication for first party DMA transfer.

18. The method of claim 14, wherein the parameters comprise a tag for indexing queued commands.

19. The method of claim 14, wherein the command comprise a tag for queuing index.

20. The method of claim 14, wherein the predefined packet is a Register FIS comprising a read command to read 2048 bytes data format media.

21. The method of claim 14, wherein the predefined packet is a Register FIS containing a write command to write 2048 bytes data format media.

22. The method of claim 14 wherein said completion packet is a Register FIS for clearing a busy flag of the host.

23. The method of claim 14 wherein said completion packet is a Set Device Bits FIS.

24. The method of claim 14, wherein the command is a command instruction which comprising essential information for executing the command.

25. A method for transmitting a command to an ATAPI device, comprising:
receiving an command;
sending a predefined packet comprising essential information regarding said command and a plurality of parameters over a Serial ATA interface to a device, wherein one of the parameters indicates whether the command is a NCQ command;
receiving a completion packet from the device coupled to the Serial ATA interface for indicating that the ATAPI command was executed.

26. The method of claim 25, wherein the predefined packet is a new defined FIS.

27. The method of claim 25, wherein the predefined packet is a new defined Register FIS.

28. The method of claim 25, wherein the parameters comprise a tag number for indexing queued commands.

29. The method of claim 25, wherein the essential information comprise a tag number for indexing queued commands.

30. The method of claim 25, wherein the essential information is a 12 bytes CDB.

31. The method of claim 25 wherein said completion packet is a FIS for clearing a busy flag of the host.

32. The method of claim 25 wherein said completion packet is a Set Device Bits FIS.

33. The method of claim 25, wherein the predefined packet is a Register FIS comprising a read command to read 2048 bytes data format media.

34. The method of claim 25, wherein the predefined packet is a Register FIS comprising a write command to write 2048 bytes data format media.

35. A method for executing a host command in an ATAPI device, comprising:
receiving a predefined packet comprising essential information regarding said command, the predefined packet received from a Serial ATA interface that is coupled to a host, wherein the essential information further indicates whether the command is a NCQ command;
executing the command received from the host in the predefined packet; and
sending a completion packet to the host over the Serial ATA interface for indicating that the command was executed.

36. The method of claim 35, wherein the predefined packet is a new defined FIS.

37. The method of claim 35, wherein the predefined packet is a new defined Register FIS.

38. The method of claim 35, wherein the essential information comprises a tag for indexing queued commands.

39. The method of claim 35 wherein said completion packet is a Register FIS for clearing a busy flag of the host.

40. The method of claim 35 wherein said completion packet is a Set Device Bits FIS.

41. A method for transmitting a command to an ATAPI device, comprising:
receiving an command;
sending a predefined packet comprising essential information regarding said command over a Serial ATA interface to a device, wherein the essential information further indicates whether the command is a NCQ command;
receiving a completion packet from the device coupled to the Serial ATA interface for indicating that the command was executed.

42. The method of claim 41, wherein the predefined packet is a new defined FIS.

43. The method of claim 41, wherein the predefined packet is a new defined Register FIS.

44. The method of claim 41, wherein the essential information comprise a tag number for indexing queued commands.

45. The method of claim 41 wherein said completion packet is a Register FIS for clearing a busy flag of the host.

46. The method of claim 41 wherein said completion packet is a Set Device Bits FIS.

47. A method for executing a host command in a device, comprising:
receiving a predetermined packet comprising essential information regarding said command, the predetermined packet received from a Serial ATA interface that is coupled to a host, wherein said command is executed to transmit data regarding optical media;
executing the command; and
sending a completion packet to the host over the Serial ATA interface for indicating that the command was executed.

48. The method of claim 47, wherein the predetermined packet is a new defined FIS.

49. The method of claim 47, wherein the predetermined packet is a new defined Register FIS.

50. The method of claim 47, wherein said completion packet is a Register FIS for clearing a busy flag of the host.

51. A method for transmitting a command to a device, comprising:
receiving an command;
sending a predetermined packet comprising essential information regarding said command over a Serial ATA interface to a device, wherein said command is executed to transmit data regarding optical media; and
receiving a completion packet from the device coupled to the Serial ATA interface for indicating that the command was executed.

52. The method of claim 51, wherein the predetermined packet is a new defined FIS.

53. The method of claim 51, wherein the predetermined packet is a new defined Register FIS.

54. The method of claim 51 wherein said completion packet is a Register FIS for clearing a busy flag of the host.
